(19) United States
(12) Patent Application Publication
(10) Pub. No.: US 2026/0088504 A1
(43) Pub. Date: Mar. 26, 2026

(54) ANTENNA MODULE, SUBSTRATE CONNECTION STRUCTURE, AND COMMUNICATION DEVICE

(71) Applicant: Murata Manufacturing Co., Ltd., Nagaokakyo-shi (JP)

(72) Inventors: Yuya DOKAI, Nagaokakyo-shi (JP); Hirotsugu MORI, Nagaokakyo-shi (JP)

(73) Assignee: Murata Manufacturing Co., Ltd., Nagaokakyo-shi (JP)

(21) Appl. No.: 19/409,737

(22) Filed: Dec. 5, 2025

Related U.S. Application Data
(63) Continuation of application No. PCT/JP2024/023335, filed on Jun. 27, 2024.

(30) Foreign Application Priority Data
Aug. 8, 2023 (JP) 2023-129131

(51) Int. Cl. H01Q 5/307; H01Q 1/42

(52) U.S. Cl. CPC H01Q 5/307; H01Q 1/422

(57) ABSTRACT

An antenna module includes dielectric substrates, ground electrodes, radiation electrodes, and a feed line. The dielectric substrates are flat. A third dielectric substrate is connected to rear surfaces of the first and second dielectric substrates and is rigid. A first radiation electrode is disposed at the first dielectric substrate closer to a top surface with respect to a first ground electrode. A second radiation electrode is disposed at the second dielectric substrate closer to a top surface with respect to a second ground electrode. A third ground electrode is disposed at a third dielectric substrate to electrically connect the first and second ground electrodes. The feed line is disposed at the third dielectric substrate to transmit a high-frequency signal from the first dielectric substrate to the second dielectric substrate. A normal direction of the first dielectric substrate and a normal direction of the second dielectric substrate differ from each other.

### CROSS-REFERENCE TO RELATED APPLICATIONS

This application is a continuation of International Application No. PCT/JP2024/023335, filed on Jun. 27, 2024, which claims priority to Japanese Patent Application No. 2023-129131, filed on Aug. 8, 2023. The entire disclosures of the prior applications are hereby incorporated by reference in their entirety.

### TECHNICAL FIELD

The present disclosure relates to an antenna module, a substrate connection structure, and a communication device, and more specifically relates to a technology of improving antenna characteristics of an antenna module capable of bidirectionally radiating radio waves.

### BACKGROUND ART

International Publication No. 2019/163419 (Patent Document 1) describes a structure of an antenna module including two dielectric substrates disposed at a flexible substrate and an antenna element disposed at each dielectric substrate. In this antenna module, the flexible substrate is bent to vary normal directions of the two dielectric substrates. Thus, the antenna module can bidirectionally radiate radio waves in two different directions.

### CITATION LIST

### Patent Document

Patent Document 1: International Publication No. 2019/163419

### SUMMARY

### Technical Problems

In the antenna module described in Patent Document 1, the two dielectric substrates are respectively disposed at two flat portions of the flexible substrate that are connected together with a bend. A ground electrode and a feed line are disposed in the flexible substrate to transmit high-frequency signals to the antenna elements.

In the antenna module in Patent Document 1, the flexible substrate originally having a flat shape is bent to vary the normal directions of the two dielectric substrates. When the flexible substrate is bent, the feed line and the ground electrode extending through the flexible substrate expand and contract. Thus, the line width may be changed or the distance between the feed line and the ground electrode may be changed, and the designed dimensions of the flexible substrate may thus be changed. Alternatively, deformation resulting from the bending may cause a defect in the feed line and/or the ground electrode, such as a crack or disconnection.

In this case, the impedance of the feed line in an actually obtained antenna module may be changed from that intended when designed, and the antenna module may fail to have desired antenna characteristics.

The present disclosure is made to address such an issue, and aims to maintain the antenna characteristics of an antenna module capable of bidirectionally radiating radio waves.

### Solutions to Problems

An antenna module according to an aspect of the present disclosure includes a first substrate to a third substrate, a first ground electrode to a third ground electrode, a first antenna element and a second antenna element, and a feed line. The first substrate has a flat shape, and has a first surface and a second surface opposite to each other. The second substrate has a flat shape, and has a third surface and a fourth surface opposite to each other. The third substrate is connected to the second surface of the first substrate and the fourth surface of the second substrate, and has no flexibility. The first antenna element is disposed at the first substrate at a position closer to the first surface with respect to the first ground electrode. The second antenna element is disposed at the second substrate at a position closer to the third surface with respect to the second ground electrode. The first ground electrode is disposed at the first substrate, and the second ground electrode is disposed at the second substrate. The third ground electrode is disposed at the third substrate, and electrically connects the first ground electrode and the second ground electrode to each other. The feed line is disposed at the third substrate, and transmits a high-frequency signal from the first substrate to the second substrate. When a normal direction of the first substrate is defined as a first direction, and a normal direction of the second substrate is defined as a second direction, the first direction and the second direction differ from each other.

A substrate connection structure according to another aspect of the present disclosure includes a first substrate to a third substrate, a first ground electrode to a third ground electrode, and a feed line. The first substrate and the second substrate each have a flat shape capable of receiving a radiation electrode. The third substrate is connected to the first substrate and the second substrate, and has no flexibility. The first ground electrode is disposed at the first substrate, and the second ground electrode is disposed at the second substrate. The third ground electrode is disposed at the third substrate, and electrically connects the first ground electrode and the second ground electrode to each other. The feed line is disposed at the third substrate, and transmits a high-frequency signal from the first substrate to the second substrate. A normal direction of the first substrate and a normal direction of the second substrate differ from each other.

### Advantageous Effects

In the antenna module according to the present disclosure, the two substrates (the first substrate and the second substrate) at each of which the antenna element is disposed are connected to each other with the third substrate having no flexibility, and a ground path and a signal path between the two substrates are connected with the feed line and the ground electrode (the third ground electrode) disposed at the third substrate. The third substrate has a rigid structure with no flexibility, and does not have to be bent. This structure reduces an impedance change involved in bending, and allows the feed line to have a stable impedance. An antenna module capable of bidirectionally radiating radio waves with this structure can thus maintain antenna characteristics.

### BRIEF DESCRIPTION OF DRAWINGS

FIG. 1 is an overall schematic diagram of a communication device including an antenna module according to a first embodiment.

FIG. 2 is a perspective view of the antenna module according to the first embodiment.

FIG. 3 is a rear perspective view of the antenna module illustrated in FIG. 2.

FIG. 4 is a side perspective view of the antenna module illustrated in FIG. 2, illustrating a feed path viewed in plan in an X-axis direction.

FIG. 5 is a side perspective view of the antenna module illustrated in FIG. 2, illustrating a ground path viewed in plan in the X-axis direction.

FIG. 6 is a rear perspective view of an antenna module according to a first modification example.

FIG. 7 is a side perspective view of the antenna module in FIG. 6 when viewed in plan in the X-axis direction.

FIG. 8 is a rear perspective view of an antenna module according to a second modification example.

FIG. 9 is a rear perspective view of an antenna module according to a third modification example.

FIG. 10 is a rear perspective view of an antenna module according to a fourth modification example.

FIG. 11 is a side perspective view of an antenna module according to a fifth modification example when viewed in plan in the X-axis direction.

FIG. 12 is a side perspective view of an antenna module according to a sixth modification example when viewed in plan in the X-axis direction.

FIG. 13 is a side perspective view of an antenna module according to a seventh modification example when viewed in plan in the X-axis direction.

FIG. 14 is a side perspective view of an antenna module according to a second embodiment when viewed in plan in the X-axis direction.

FIG. 15 is a side perspective view of an antenna module including a substrate connection structure according to a third embodiment when viewed in plan in the X-axis direction.

### DESCRIPTION OF EMBODIMENTS

Embodiments of the present disclosure are described below in detail with reference to the drawings. In the drawings, the same reference signs denote the same or equivalent components, which are not described repeatedly.

### First Embodiment

### (Basic Structure of Communication Device)

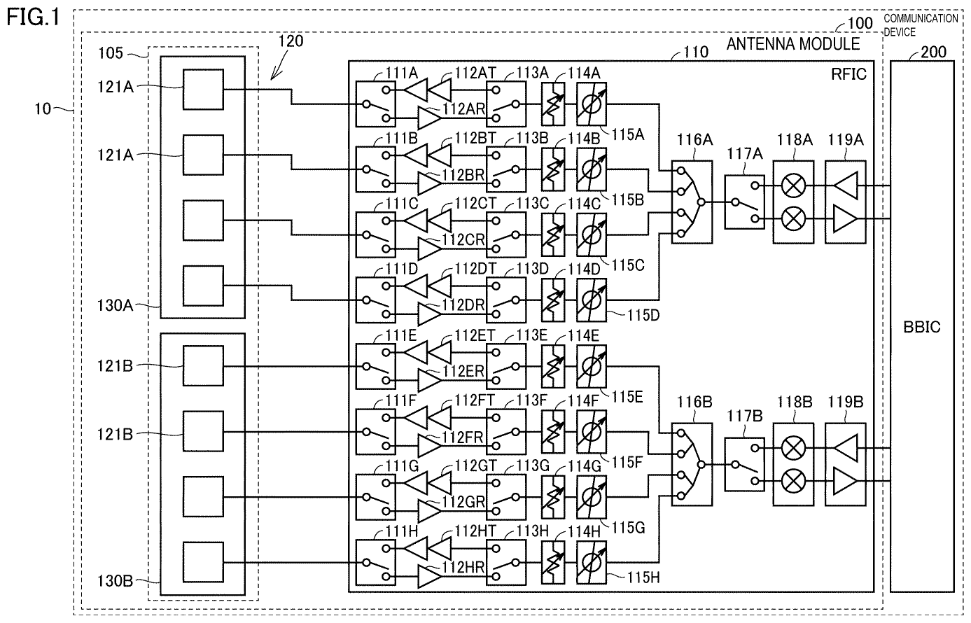

FIG. 1 is a block diagram of a communication device 10 including an antenna module 100 according to the first embodiment. The communication device 10 is, for example, a mobile terminal such as a mobile phone, smartphone, or a tablet, or a personal computer having a communication function. A frequency band of radio waves used in the antenna module 100 according to the first embodiment is, for example, a band of millimeter-wave radio waves having center frequencies of 28 GHz, 39 GHz, and 60 GHz, but a different frequency band of radio waves may be used.

With reference to FIG. 1, the communication device 10 includes the antenna module 100, and a baseband integrated circuit (BBIC) 200 forming a baseband signal processing circuit. The antenna module 100 includes a radio frequency integrated circuit (RFIC) 110 that provides high-frequency signals, and an antenna device 120. The RFIC 110, and/or a module containing it, e.g., a SiP module (125) described below, may be collectively referred to as a feeder circuit. The communication device 10 upconverts a signal transmitted from the BBIC 200 to the antenna module 100 into a high-frequency signal, and then radiates the high-frequency signal from the antenna device 120, and downconverts a high-frequency signal received at the antenna device 120, and then processes the high-frequency signal with the BBIC 200.

The antenna device 120 includes two dielectric substrates 130A and 130B having a flat shape and at each of which antenna elements are disposed. As an example of antenna elements, at least one radiation electrode is disposed at each dielectric substrate. In the structure illustrated in FIG. 1 as an example, four radiation electrodes 121A are disposed at the dielectric substrate 130A, and four radiation electrodes 121B are disposed at the dielectric substrate 130B, but the number of radiation electrode disposed at each substrate is not limited to this. In the structure illustrated in FIG. 1 as an example, multiple radiation electrodes are arranged at each dielectric substrate in a line in a one-dimensional array, but may be arranged in a two-dimensional array at each substrate. Alternatively, a single radiation electrode may be disposed at each substrate. In the first embodiment, the radiation electrodes 121A and 121B are patch antennas having a substantially square and flat shape.

The RFIC 110 includes switches 111A to 111H, 113A to 113H, 117A, and 117B, power amplifiers 112AT to 112HT, low-noise amplifiers 112AR to 112HR, attenuators 114A to 114H, phase shifters 115A to 115H, signal combiner/splitters 116A and 116B, mixers 118A and 118B, and amplifier circuits 119A and 119B. Among these, a structure including the switches 111A to 111D, 113A to 113D, and 117A, the power amplifiers 112AT to 112DT, the low-noise amplifiers 112AR to 112DR, the attenuators 114A to 114D, the phase shifters 115A to 115D, the signal combiner/splitter 116A, the mixer 118A, and the amplifier circuit 119A serves as a circuit for a high-frequency signal radiated from the radiation electrodes 121A of the dielectric substrate 130A. A structure including the switches 111E to 111H, 113E to 113H, and 117B, the power amplifiers 112ET to 112HT, the low-noise amplifiers 112ER to 112HR, the attenuators 114E to 114H, the phase shifters 115E to 115H, the signal combiner/splitter 116B, the mixer 118B, and the amplifier circuit 119B serves as a circuit for a high-frequency signal radiated from the radiation electrodes 121B of the dielectric substrate 130B.

To transmit high-frequency signals, the switches 111A to 111H and 113A to 113H are switched to the power amplifiers 112AT to 112HT, and the switches 117A and 117B are connected to transmission-side amplifiers of the amplifier circuits 119A and 119B. To receive high-frequency signals, the switches 111A to 111H and 113A to 113H are switched to the low-noise amplifiers 112AR to 112HR, and the switches 117A and 117B are connected to reception-side amplifiers of the amplifier circuits 119A and 119B.

A signal transmitted from the BBIC 200 is amplified by the amplifier circuits 119A and 119B, and upconverted by the mixers 118A and 118B. A transmission signal, or an upconverted high-frequency signal, is divided into four waves by the signal combiner/splitters 116A and 116B, and the waves are provided to the respective radiation electrodes 121A and 121B through corresponding signal paths. The phase shift of each of the phase shifters 115A to 115H disposed at the corresponding signal path is individually adjusted to adjust directivity of radio waves output from the radiation electrode disposed at each substrate. The attenuators 114A to 114H adjust the strength of transmission signals.

Reception signals or high-frequency signals received at the radiation electrodes 121A and 121B are transmitted to the RFIC 110, respectively pass through four signal paths, and then are combined by the signal combiner/splitters 116A and 116B. The combined reception signal is downconverted by the mixers 118A and 118B, then amplified by the amplifier circuits 119A and 119B, and transmitted to the BBIC 200.

The RFIC 110 is formed as, for example, a 1-chip integrated circuit component having the above circuit configuration. Alternatively, devices (switches, power amplifiers, low-noise amplifiers, attenuators, and phase shifters) in the RFIC 110 corresponding to the radiation electrodes 121A and 121B may be formed as 1-chip integrated circuit components for the corresponding radiation electrodes.

### (Structure of Antenna Module)

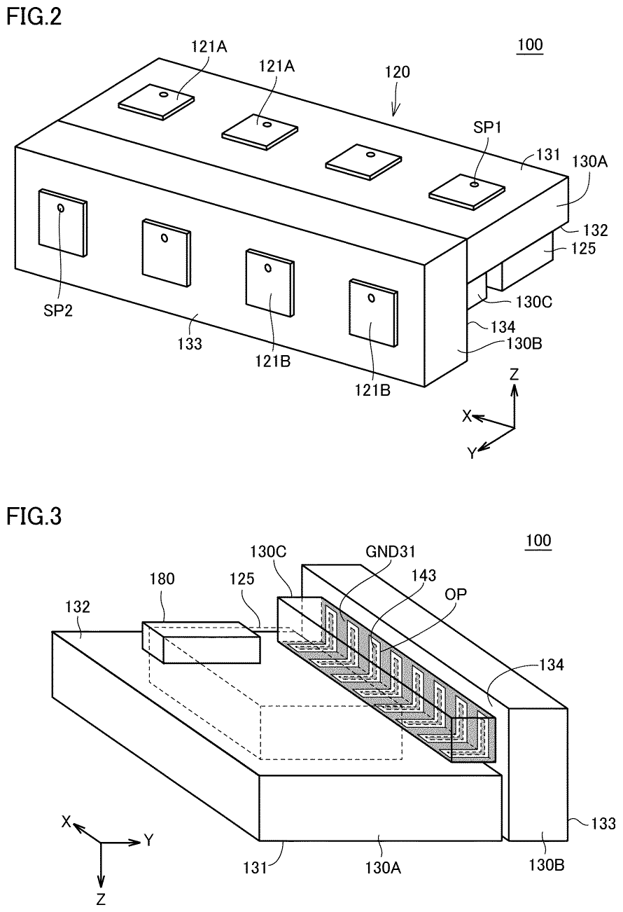

With reference to FIG. 2 to FIG. 5 now, the structure of the antenna module 100 according to the present embodiment is described in detail. FIG. 2 is a perspective view of the antenna module 100, when viewed from the dielectric substrate 130B. FIG. 3 is a perspective view (rear perspective view) of the antenna module 100 in FIG. 2, when viewed from the rear.

In the description below, the arrangement direction of the antenna elements at each dielectric substrate is defined as an X-axis direction, the normal direction of the dielectric substrate 130B is defined as a Y-axis direction, and the normal direction of the dielectric substrate 130A is defined as a Z-axis direction. A main surface 131 of the dielectric substrate 130A facing in the positive Z-axis direction is also referred to as “a top surface 131”, and a main surface 132 of the dielectric substrate 130A facing in the negative Z-axis direction is also referred to as “a rear surface 132”. A main surface 133 of the dielectric substrate 130B facing in the positive Y-axis direction is also referred to as “a top surface 133”, and a main surface 134 of the dielectric substrate 130B facing in the negative Y-axis direction is also referred to as “a rear surface 134”.

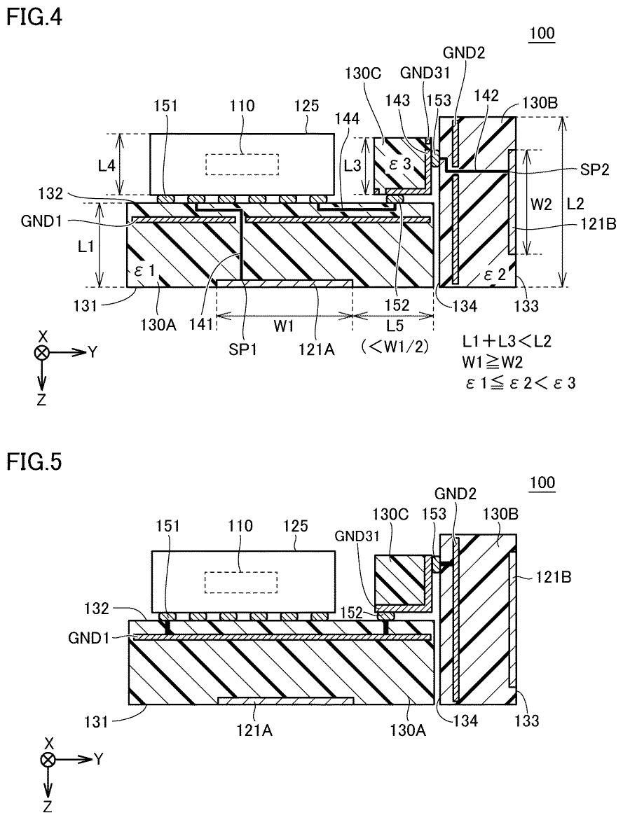

FIG. 4 and FIG. 5 are side perspective views of the antenna module 100, when viewed in plan in the negative X-axis direction. FIG. 4 is a diagram of a feed path, and FIG. 5 is a diagram of a ground path.

With reference to FIG. 2 to FIG. 5, the antenna module 100 includes, in addition to the dielectric substrates 130A and 130B and the radiation electrodes 121A and 121B, a dielectric substrate 130C, a system in package (SiP) module 125, and a connector 180. The SiP module 125 is a circuit board that receives, therein, a power management IC and a power inductor, and the RFIC 110. In FIG. 3, the SiP module 125 is drawn with broken lines to facilitate viewability of the dielectric substrate 130C.

In the antenna module 100, the two dielectric substrates 130A and 130B are disposed to allow a side surface of the dielectric substrate 130A to face the rear surface 134 of the dielectric substrate 130B, and to allow the top surface 131 of the dielectric substrate 130A to substantially coincide with a side surface of the dielectric substrate 130B. In other words, as illustrated in FIG. 4 and FIG. 5, the dielectric substrates 130A and 130B are connected together with the dielectric substrate 130C to be formed into a substantially L shape when viewed in plan in the X-axis direction.

Each of the dielectric substrates 130A, 130B, and 130C is, for example, a low temperature co-fired ceramics (LTCC) multilayer substrate, a multilayer resin substrate formed from multiple laminated resin layers formed from a resin such as epoxy or polyimide, a multilayer resin substrate formed from multiple laminated resin layers formed from a liquid crystal polymer (LCP) having a lower dielectric constant, a multilayer resin substrate formed from multiple laminated resin layers formed from fluororesin, or a ceramic multilayer substrate other than the LTCC multilayer substrate. The dielectric substrates 130A, 130B, and 130C may each be a single-layer substrate, instead of having a multilayer structure.

In the antenna module 100, the four radiation electrodes 121A or 121B are disposed on each of the two dielectric substrates 130A and 130B to serve as antenna elements. In an example described below, for ease of understanding, the radiation electrodes 121A and 121B are respectively disposed on the top surfaces of the dielectric substrates 130A and 130B while being exposed, but the radiation electrodes 121A and 121B may be disposed in the dielectric substrates 130A and 130B.

The dielectric substrate 130A is a rectangular prism having main surfaces (the top surface 131 and the rear surface 132) of a substantially rectangular shape, and the four radiation electrodes 121A are arranged on the top surface 131 in a line in the X-axis direction. The SiP module 125 and the connector 180 are connected to the rear surface 132 of the dielectric substrate 130A with solder bumps 151. The antenna module 100 can be mounted on a mount substrate with the connector 180. The dielectric substrate 130A may be mounted on the mount substrate by solder joining.

At an inner layer of the dielectric substrate 130A located closer to the rear surface 132, a ground electrode GND1 is disposed throughout, along the entire surface of the dielectric substrate 130A. To each radiation electrode 121A on the dielectric substrate 130A, a high-frequency signal is transmitted from the RFIC 110 inside the SiP module 125 through feed lines 141. Each feed line 141 is connected to a feed point SP1 offset in the negative Y-axis direction from the center of the corresponding radiation electrode 121A. When a high-frequency signal is provided to each radiation electrode 121A through the feed line 141, a radio wave polarized in the Y-axis direction is radiated in the positive Z-axis direction.

The dielectric substrate 130B is a rectangular prism having main surfaces (the top surface 133 and the rear surface 134) of a substantially rectangular shape, and the four radiation electrodes 121B are arranged on the top surface 133 in a line in the X-axis direction. At an inner layer of the dielectric substrate 130B located closer to the rear surface 134, a ground electrode GND2 is disposed throughout, along the entire surface of the dielectric substrate 130B. To each radiation electrode 121B on the dielectric substrate 130B, a high-frequency signal is transmitted from the RFIC 110 inside the SiP module 125 through a corresponding feed line 144 in the dielectric substrate 130A, a corresponding feed line 143 in the dielectric substrate 130C, and a corresponding feed line 142 in the dielectric substrate 130B. Each feed line 142 is connected to a feed point SP2 offset in the negative Z-axis direction from the center of the corresponding radiation electrode 121B. When a high-frequency signal is provided to each radiation electrode 121B through the corresponding feed lines 142, 143, and 144, a radio wave polarized in the Z-axis direction is radiated in the positive Y-axis direction.

A dielectric constant ε2 of the dielectric substrate 130B is set greater than or equal to a dielectric constant ε1 of the dielectric substrate 130A (ε1≤ε2). Particularly, when the dielectric constant s2 is set greater than the dielectric constant ε1, regardless of when radio waves of the same frequency are radiated from the radiation electrodes 121A and 121B, a size W2 of the radiation electrodes 121B can be reduced further than a size W1 of the radiation electrodes 121A. Thus, the dimension of the dielectric substrate 130B in the Z-axis direction can be reduced, and the height of the antenna module 100 can be reduced. When the radiation electrodes 121A and the radiation electrodes 121B radiate radio waves of different frequencies, radiation electrodes corresponding to a relatively high frequency are provided as the radiation electrodes 121B. Thus, the dimension of the dielectric substrate 130B in the Z-axis direction can be reduced. More specifically, in view of height reduction, the size W2 of the radiation electrodes 121B may be smaller than or equal to the size W1 of the radiation electrodes 121A (W1≥W2).

The dielectric substrate 130C is a rectangular prism having a YZ plane with a substantially square shape. The dielectric substrate 130C is a rigid substrate having no flexibility. A rigid substrate having no flexibility is one that is not bent into shape and is sufficiently stiff to resist deformation (like expansion or contraction), thereby ensuring that the dimensions of the feed line remain stable and the impedance does not change from its designed value. The dielectric substrate 130C is connected to the rear surface 132 of the dielectric substrate 130A with solder bumps 152 interposed therebetween, and connected to the rear surface 134 of the dielectric substrate 130B with solder bumps 153 interposed therebetween.

When viewed in plan in the normal direction (the Z-axis direction) of the dielectric substrate 130A, the dielectric substrate 130C is disposed between the SiP module 125 and the dielectric substrate 130B without overlapping the radiation electrodes 121A. In contrast, when viewed in the normal direction (the Y-axis direction) of the dielectric substrate 130B, the dielectric substrate 130C overlaps the radiation electrodes 121B.

A ground electrode GND31 and multiple feed lines 143 are disposed from a surface of the dielectric substrate 130C facing the rear surface 132 of the dielectric substrate 130A to a surface of the dielectric substrate 130C facing the rear surface 134 of the dielectric substrate 130B. The multiple feed lines 143 are strip-like flat electrodes, and disposed in corresponding openings OP formed in the ground electrode GND31.

Although FIG. 4 and FIG. 5 illustrate an example where the ground electrode GND31 and the feed lines 143 are disposed on the outer surface of the dielectric substrate 130C, the ground electrode GND31 and the feed lines 143 may be disposed at an inner layer of the dielectric substrate 130C. As illustrated in FIG. 4, a first end of each feed line 143 is connected to the corresponding feed line 144 in the dielectric substrate 130A with the corresponding solder bump 152 interposed therebetween. A second end of each feed line 143 is connected to the corresponding feed line 142 in the dielectric substrate 130B with the corresponding solder bump 153 interposed therebetween. With this structure, the feed lines 143 function as signal paths that transmit high-frequency signals to the radiation electrodes 121B.

As illustrated in FIG. 5, the ground electrode GND31 is connected to the ground electrode GND1 inside the dielectric substrate 130A and the ground electrode GND2 inside the dielectric substrate 130B. With this structure, the ground electrode GND31 functions as a ground path having the same polarity as the ground electrodes GND1 and GND2.

A structure with an L shape such as the antenna module 100 can be achieved using the dielectric substrate 130C, by connecting the dielectric substrate 130A and the dielectric substrate 130C to each other with solder and by connecting the dielectric substrate 130B and the dielectric substrate 130C to each other with solder. Alternatively, a portion where the dielectric substrate 130A and the dielectric substrate 130B face each other may be molded using a resin or an adhesive.

As illustrated in FIG. 3, in the rigid dielectric substrate 130C, the feed lines 143 and the ground electrode GND31 extending along both sides of the feed lines 143 in an extension direction form coplanar lines. Thus, the impedance of a signal path from the RFIC 110 to each radiation electrode 121B can be stably set to a characteristic impedance (such as 50Ω). Thus, compared to a structure where the flexible substrate is bent as in Patent Document 1 described above, the present structure can restrict a change of the impedance of a signal path, maintain antenna characteristics otherwise lowered by impedance mismatching, and improve the antenna characteristics.

When dimensions, in the Z-axis direction, of the dielectric substrates 130A, 130B, and 130C and the SiP module 125 are defined as L1, L2, L3, and L4, L2>L1+L3 and L3<L4. With these dimensions, the antenna module 100 can reduce its height with the reduction of the dimension in the Z-axis direction. When the dielectric constant ε3 of the dielectric substrate 130C is set greater than the dielectric constants ε1 and ε2 of the dielectric substrates 130A and 130B, the size of the dielectric substrate 130C can be reduced.

In the dielectric substrate 130A, a shortest distance L5 from the end portion of each radiation electrode 121A in the Y-axis direction to the end portion of the dielectric substrate 130A in the Y-axis direction is less than or equal to half the size W1 of the radiation electrode 121A. In this structure, the length of a connection electrode pad disposed at the dielectric substrate 130C can be further reduced than the size of each radiation electrode 121A. When the electrode pad at the dielectric substrate 130C is greater than or equal to the size of each radiation electrode 121A, the electrode pad is excited by a high-frequency signal and/or its harmonic wave, and a spurious emission may occur. Thus, the electrode pad at the dielectric substrate 130C is set to have a smaller size than each radiation electrode 121A to reduce a spurious emission that may be caused by the electrode pad.

“The dielectric substrate 130A”, “the dielectric substrate 130B”, and “the dielectric substrate 130C” in the first embodiment respectively correspond to examples of “a first substrate”, “a second substrate”, and “a third substrate” in the present disclosure. “The ground electrode GND1”, “the ground electrode GND2”, and “the ground electrode GND31” in the first embodiment correspond to examples of “a first ground electrode”, “a second ground electrode”, and “a third ground electrode” in the present disclosure. “The radiation electrodes 121A” and “the radiation electrodes 121B” in the first embodiment correspond to examples of “a first antenna element” and “a second antenna element” in the present disclosure. “The top surface 131”, “the rear surface 132”, “the top surface 133”, and “the rear surface 134” in the first embodiment correspond to examples of “a first surface” to “a fourth surface” in the present disclosure. “Each feed line 143” in the first embodiment corresponds to an example of “a feed line” in the present disclosure.

### First Modification Example

In a first modification example, another arrangement example of ground electrodes disposed at the dielectric substrate 130C is described.

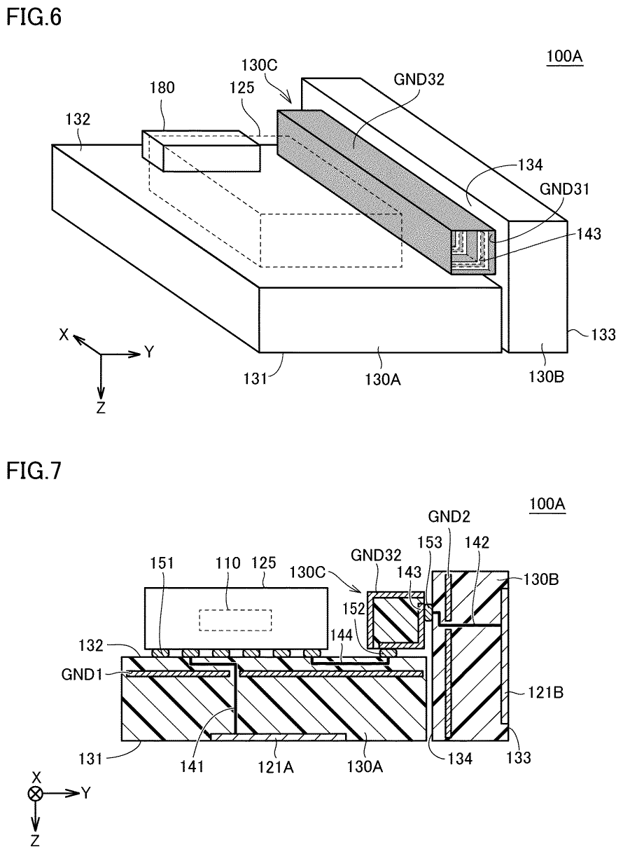

FIG. 6 is a rear perspective view of an antenna module 100A. FIG. 7 is a side perspective view of the antenna module 100A when viewed in plan in the X-axis direction. In the antenna module 100A, a ground electrode GND32 is further disposed on surfaces of the dielectric substrate 130C opposite to the feed lines 143 and the ground electrode GND31. Other components are arranged in the antenna module 100A in the same manner as those in the antenna module 100 according to the first embodiment, and the same components as those in the antenna module 100 are not repeatedly described.

The ground electrode GND32 is disposed throughout the main surface of the dielectric substrate 130C in the negative Y-axis direction and the main surface of the dielectric substrate 130C in the negative Z-axis direction. In this structure, the feed lines 143 can form grounded coplanar lines. Also in this case, the impedance of the feed lines 143 can be set to a characteristic impedance.

When the ground electrode GND32 is disposed at the dielectric substrate 130C, the ground electrode GND31 may be eliminated. In this case, the ground electrode GND32 is disposed on the surface opposite to the feed lines 143, and the feed lines 143 thus form a microstrip line. Also in this case, the impedance of the feed lines 143 can be set to a characteristic impedance.

Each of “the ground electrodes GND31 and GND32” in the first modification example corresponds to “a third ground electrode” in the present disclosure.

### Second Modification Example

In a structure according to a second modification example, the dielectric substrate 130C is formed from individual sub-substrates corresponding to the radiation electrodes 121B.

FIG. 8 is a rear perspective view of an antenna module 100B according to the second modification example. In the antenna module 100B, the dielectric substrate 130C that connects the dielectric substrate 130A and the dielectric substrate 130B to each other and that forms a signal path and a ground path is formed from sub-substrates 130C1 to 130C4. The four sub-substrates 130C1 to 130C4 respectively correspond to the four radiation electrodes 121B disposed at the dielectric substrate 130B. At each sub-substrate, the feed line 143 to the corresponding radiation electrode 121B and the ground electrode GND32 are disposed. Each sub-substrate does not have to receive both the signal path and the ground path, and each sub-substrate may have a different function of the transmission path. For example, only a signal path may be disposed at the sub-substrate 130C2, and only a ground path may be disposed at each of the sub-substrates 130C1 and 130C3 adjacent to the sub-substrate 130C2.

As described above, the structure using individual sub-substrates corresponding to radiation electrodes can thus flexibly accept a change of the number of radiation electrodes 121B disposed at the dielectric substrate 130B, by adding the same sub-substrates.

As in the first modification example, the ground electrode GND32 may be used at the sub-substrates according to the second modification example.

Each of “the sub-substrates 130C1 to 130C4” in the second modification example corresponds to an example of “a second sub-substrate” in the present disclosure.

### Third Modification Example

In a structure according to a third modification example, the dielectric substrate 130B is formed from sub-substrates individually receiving the radiation electrodes 121B.

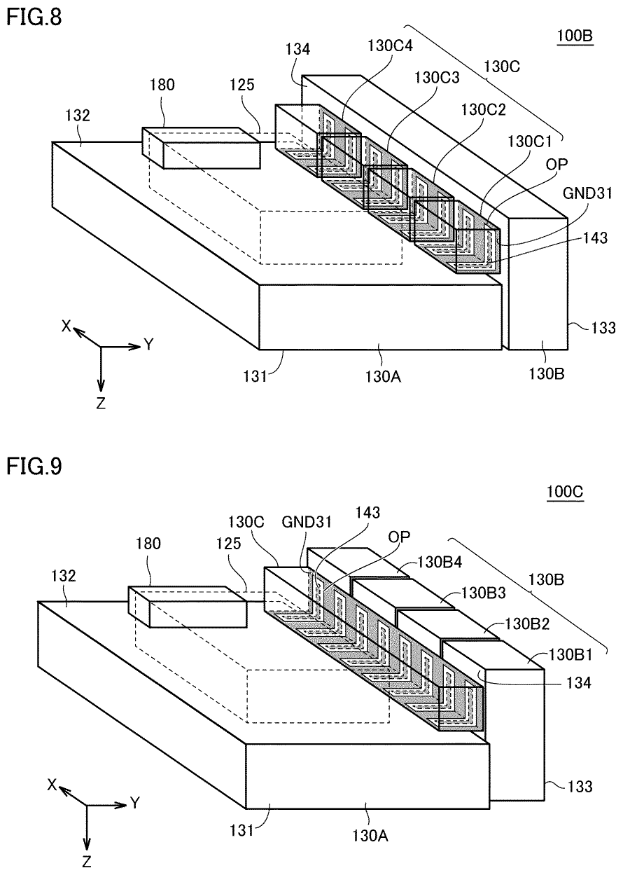

FIG. 9 is a rear perspective view of an antenna module 100C according to the third modification example. In the antenna module 100C, the dielectric substrate 130B is formed from four sub-substrates 130B1 to 130B4. Although hidden by sub-substrates in FIG. 9, one radiation electrode 121B is disposed at each of the sub-substrates 130B1 to 130B4. The sub-substrates 130B1 to 130B4 are connected to one dielectric substrate 130C.

When a dielectric substrate is formed from a single large substrate, the dielectric substrate may be largely affected by strain such as warpage caused during the manufacture, and may be fissured or cracked when mounted. When the dielectric substrate 130B is formed from the individual sub-substrates 130B1 to 130B4 for each radiation electrodes 121B as in the third modification example, the effect, such as strain, on a substrate can be reduced, and thus the product reliability can be improved. In addition, the number of radiation electrodes can be easily changed. This structure can thus flexibly accept user demands for specifications.

Each of “the sub-substrates 130B1 to 130B4” in the third modification example corresponds to an example of “a first sub-substrate” in the present disclosure.

### Fourth Modification Example

In a structure according to a fourth modification example, the second modification example and the third modification example are combined, more specifically, each of the dielectric substrate 130B and the dielectric substrate 130C is formed from sub-substrates for the corresponding radiation electrode 121B.

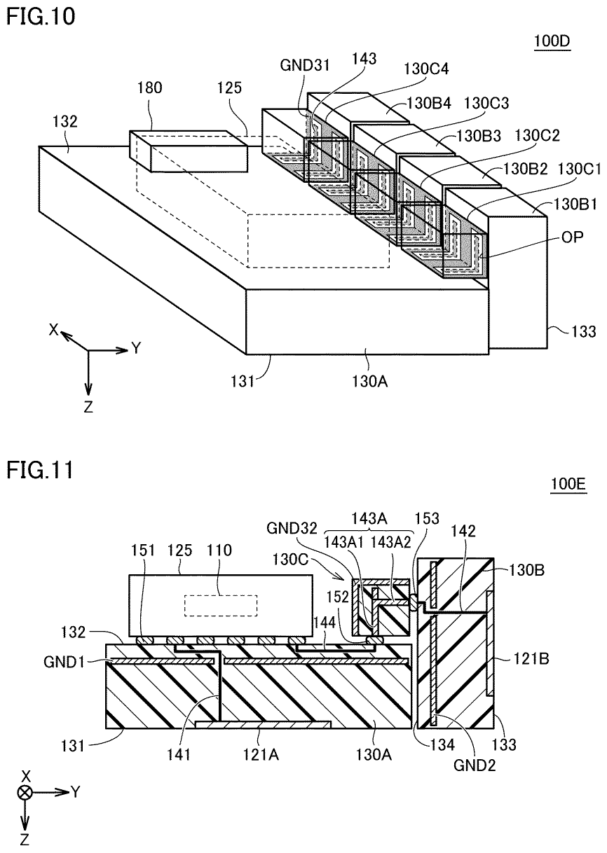

FIG. 10 is a rear perspective view of an antenna module 100D according to a fourth modification example. In the antenna module 100D, the dielectric substrate 130B is formed from four sub-substrates 130B1 to 130B4, and the dielectric substrate 130C is formed from sub-substrates 130C1 to 130C4 corresponding to the sub-substrates 130B1 to 130B4.

In this structure, the number of radiation electrodes 121B can be set as appropriate, and the dielectric substrate 130C can be disposed corresponding to the radiation electrodes 121B.

Each of “the sub-substrates 130B1 to 130B4” in the fourth modification example corresponds to an example of “a first sub-substrate” in the present disclosure. Each of “the sub-substrates 130C1 to 130C4” in the fourth modification example corresponds to an example of “a second sub-substrate” in the present disclosure.

### Fifth Modification Example

In a structure according to a fifth modification example, feed lines in the dielectric substrate 130C are disposed at an inner layer of a substrate.

FIG. 11 is a side perspective view of an antenna module 100E according to a fifth modification example when viewed in plan in the X-axis direction. In the antenna module 100E, the dielectric substrate 130C includes feed lines 143A and a ground electrode GND32. As in the case of the second modification example, the ground electrode GND32 is disposed throughout the entire main surface of the dielectric substrate 130C in the negative Y-axis direction and the main surface of the dielectric substrate 130C in the negative Z-axis direction.

The feed lines 143A are disposed at an inner layer of the dielectric substrate 130C. More specifically, each feed line 143A includes a first portion 143A1, extending in the negative Z-axis direction from the surface facing the dielectric substrate 130A, and a second portion 143A2, extending in the positive Y-axis direction from the first portion 143A1 to the surface facing the dielectric substrate 130B. The first portion 143A1 faces the ground electrode GND32 on the main surface facing in the negative Y-axis direction, and the second portion 143A2 faces the ground electrode GND32 on the main surface facing in the negative Z-axis direction. More specifically, the feed lines 143A and the ground electrode GND32 form a microstrip line.

This structure can also reduce fluctuations of impedance of the feed lines 143A.

By adjusting a connection portion between the first portion 143A1 and the second portion 143A2, for example, by causing a part of the first portion 143A1 to protrude from the second portion 143A2 as illustrated in FIG. 11, a stub may be formed. This structure improves impedance matching, and thus can obtain better signal transmission performance. A portion protruding in the X-axis direction from each feed line 143A may be provided to form a stub.

### Sixth Modification Example

In a structure according to a sixth modification example, the dielectric substrate 130C is disposed in a recessed portion formed in the rear surface 132 of the dielectric substrate 130A.

FIG. 12 is a side perspective view of an antenna module 100F according to a sixth modification example when viewed in plan in the X-axis direction. In the antenna module 100F, a recessed portion 160 is formed at an end portion, in the positive Y-axis direction, of the rear surface 132 of the dielectric substrate 130A. The dielectric substrate 130C is connected to the dielectric substrate 130A in the recessed portion 160.

In this structure, a dimension from the top surface 131 of the dielectric substrate 130A to the farthest point of the dielectric substrate 130C can be reduced. Thus, the height reduction of the antenna module 100F can be achieved within the range within which the dimensions of the SiP module 125 and the dielectric substrate 130B in the Z-axis direction can be reduced.

“The recessed portion 160” in the sixth modification example corresponds to an example of “a first recessed portion” in the present disclosure.

### Seventh Modification Example

In a structure according to a seventh modification example, the dielectric substrate 130C is disposed in a recessed portion formed in the rear surface 134 of the dielectric substrate 130B.

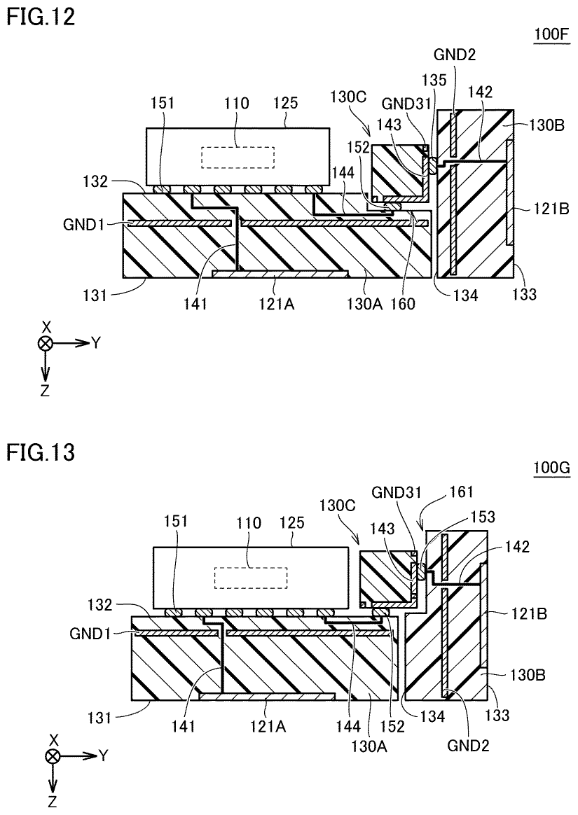

FIG. 13 is a side perspective view of an antenna module 100G according to a seventh modification example when viewed in plan in the X-axis direction. In the antenna module 100G, a recessed portion 161 is formed on the rear surface 134 of the dielectric substrate 130B at an end portion in the negative Z-axis direction. The dielectric substrate 130C is connected to the dielectric substrate 130B in the recessed portion 161.

When, for example, the dimension of the dielectric substrate 130A in the Y-axis direction is restricted and the rear surface 132 of the dielectric substrate 130A has no space to receive the SiP module 125 and the dielectric substrate 130C, this structure allows a part of the dielectric substrate 130C to protrude from the dielectric substrate 130A. Thus, the size reduction of the antenna module 100G in the Y-axis direction can be achieved.

“The recessed portion 161” in the seventh modification example corresponds to an example of “a second recessed portion” in the present disclosure.

### Second Embodiment

In a second embodiment, an antenna module is capable of radiating radio waves in three directions using a structure described in the first embodiment.

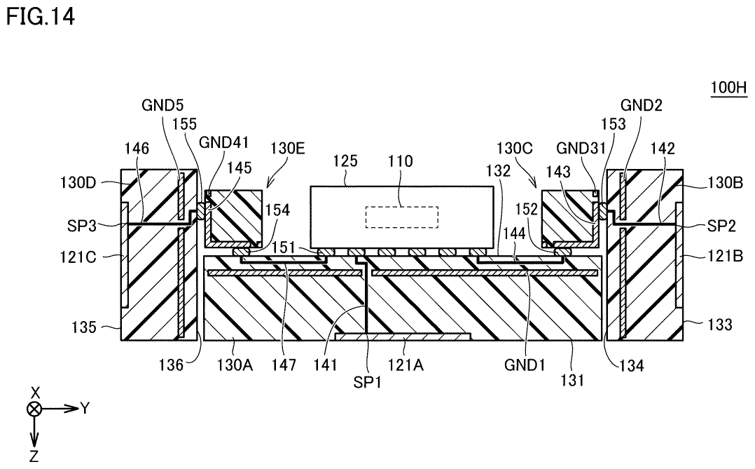

FIG. 14 is a side perspective view of an antenna module 100H according to a second embodiment when viewed in plan in the X-axis direction. The antenna module 100H includes, in addition to the components in the antenna module 100 according to the first embodiment, a dielectric substrate 130D and a dielectric substrate 130E.

The dielectric substrate 130D is disposed at an end portion of the dielectric substrate 130A in the negative Y-axis direction, and connected to the dielectric substrate 130A with the dielectric substrate 130E interposed therebetween. The dielectric substrate 130D basically has the same structure as the dielectric substrate 130B, and radiation electrodes 121C, a ground electrode GND5, and feed lines 146 are disposed in the substrate with a flat shape. In the dielectric substrate 130D, the ground electrode GND5 is disposed throughout, at an inner layer underlying the main surface (a rear surface 136) facing the dielectric substrate 130A. The radiation electrodes 121C are disposed on the main surface (a top surface 135) of the dielectric substrate 130D facing in the negative Y-axis direction.

The dielectric substrate 130E basically has the same structure as the dielectric substrate 130C, and is connected to the rear surface 132 of the dielectric substrate 130A with solder bumps 154 interposed therebetween, and connected to the rear surface 136 of the dielectric substrate 130D with solder bumps 155 interposed therebetween.

When viewed in plan in the normal direction of the dielectric substrate 130A, the dielectric substrate 130E is disposed between the SiP module 125 and the dielectric substrate 130D without overlapping the radiation electrodes 121A. In contrast, when viewed in the normal direction (the Y-axis direction) of the dielectric substrate 130D, the dielectric substrate 130E overlaps the radiation electrodes 121C.

At the dielectric substrate 130E, a ground electrode GND41 and multiple feed lines 145 are disposed from the surface facing the rear surface 132 of the dielectric substrate 130A to the surface facing the rear surface 136 of the dielectric substrate 130D. Each of the multiple feed lines 145 is a strip-like flat electrode, and is disposed in a corresponding opening formed in the ground electrode GND41.

The first end of each feed line 145 is connected to a corresponding feed line 147 in the dielectric substrate 130A with the corresponding solder bump 154 interposed therebetween. The second end of each feed line 145 is connected to a corresponding feed line 146 in the dielectric substrate 130D with the corresponding solder bump 155 interposed therebetween. In this structure, the feed lines 145 function as signal paths that transmit high-frequency signals from the RFIC 110 to the radiation electrodes 121C, together with the feed lines 146 and 147.

Each feed line 146 is connected to a feed point SP3 of the corresponding radiation electrode 121C. When a high-frequency signal is provided to the feed point SP3, a radio wave polarized in the Z-axis direction is radiated in the negative Y-axis direction from the radiation electrode 121C.

The ground electrode GND41 is connected to the ground electrode GND1 inside the dielectric substrate 130A and the ground electrode GND5 inside the dielectric substrate 130D. In this structure, the ground electrode GND41 functions as a ground path with the same potential as the ground electrodes GND1 and GND5.

With the above structure, the antenna module 100H is capable of radiating radio waves in three directions including the positive Z-axis direction and the positive and negative Y-axis directions. The dielectric substrate 130B and the dielectric substrate 130D are respectively connected with the rigid dielectric substrate 130C and the rigid dielectric substrate 130E, and thus fluctuations of impedance of the feed lines can be reduced.

### Third Embodiment

In a structure of the above example, an antenna module includes a feeder circuit and an antenna element. In a structure of a third embodiment described below, a substrate connection structure used for mounting an antenna element on a separate body such as a housing of a communication device has features of the present disclosure.

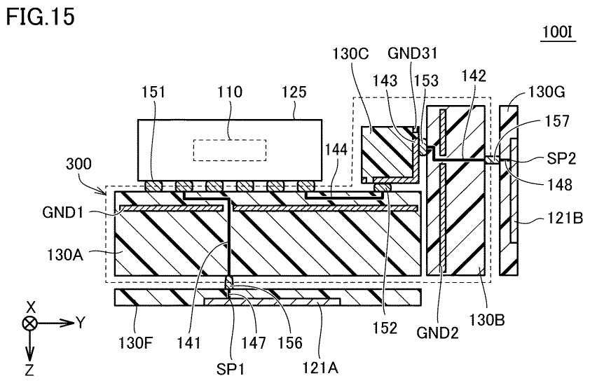

FIG. 15 is a side perspective view of an antenna module 100I including a substrate connection structure 300 according to a third embodiment when viewed in plan in the X-axis direction.

With reference to FIG. 15, in the antenna module 100I, the radiation electrodes 121A and 121B in the antenna module 100 according to the first embodiment are respectively disposed at dielectric substrates 130F and 130G, different from the dielectric substrates 130A and 130B. The substrate connection structure 300 has a structure where the dielectric substrates 130F and 130G and the SiP module 125 are removed from the antenna module 100I. The method for connecting dielectric substrates 130A, 130B, and 130C in the substrate connection structure 300 is the same as in the antenna module 100, and is thus not repeatedly described.

Feed lines 141 in the dielectric substrate 130A are connected to feed lines 147 disposed at the dielectric substrate 130F with solder bumps 156. Each feed line 147 is connected to the feed point SP1 of the corresponding radiation electrode 121A. A high-frequency signal from the RFIC 110 is provided to each radiation electrode 121A through the corresponding feed line 141 in the dielectric substrate 130A and the corresponding feed line 147 in the dielectric substrate 130F.

Feed lines 142 in the dielectric substrate 130B are connected to feed lines 148 disposed at the dielectric substrate 130G with solder bumps 157. Each feed line 148 is connected to the feed point SP2 of the corresponding radiation electrode 121B. A high-frequency signal from the RFIC 110 is provided to each radiation electrode 121B through the corresponding feed line 144 in the dielectric substrate 130A, the corresponding feed line 143 in the dielectric substrate 130C, the corresponding feed line 142 in the dielectric substrate 130B, and the corresponding feed line 148 in the dielectric substrate 130G.

Thus, in the substrate connection structure 300 that transmits high-frequency signals from the RFIC 110 to the separate radiation electrodes 121A and 121B, the dielectric substrate 130A and the dielectric substrate 130B are connected to each other with the rigid dielectric substrate 130C to reduce fluctuations of impedance of signal paths.

Thus, the antenna module 100I has improved antenna characteristics.

### Aspects

The multiple exemplary embodiments described above are understood by persons having ordinary skill in the art as specific examples of the aspects described below.

### First Aspect

An antenna module according to a first aspect includes a first substrate to a third substrate, a first ground electrode to a third ground electrode, a first antenna element and a second antenna element, and a feed line. The first substrate has a flat shape, and has a first surface and a second surface opposite to each other. The second substrate has a flat shape, and has a third surface and a fourth surface opposite to each other. The third substrate is connected to the second surface of the first substrate and the fourth surface of the second substrate, and has no flexibility. The first antenna element is disposed at the first substrate at a position closer to the first surface with respect to the first ground electrode. The second antenna element is disposed at the second substrate at a position closer to the third surface with respect to the second ground electrode. The first ground electrode is disposed at the first substrate, and the second ground electrode is disposed at the second substrate. The third ground electrode is disposed at the third substrate, and electrically connects the first ground electrode and the second ground electrode to each other. The feed line is disposed at the third substrate, and transmits a high-frequency signal from the first substrate to the second substrate. When a normal direction of the first substrate is defined as a first direction, and a normal direction of the second substrate is defined as a second direction, the first direction and the second direction differ from each other.

### Second Aspect

In the antenna module according to First Aspect, the third ground electrode and the feed line are disposed at the third substrate to face the second surface and the fourth surface, and the third ground electrode is disposed along both sides of the feed line in an extension direction of the feed line.

### Third Aspect

In the antenna module according to First or Second Aspect, the feed line is disposed at the third substrate to face the second surface and the fourth surface, and the third ground electrode is disposed at a position opposite to the feed line.

### Fourth Aspect

In the antenna module according to any one of First to Third Aspects, when viewed in plan in a normal direction of the first substrate, the first antenna element does not overlap the third substrate.

### Fifth Aspect

In the antenna module according to Fourth Aspect, a shortest distance from an end portion of the first antenna element in the second direction to an end portion of the first substrate in the second direction is less than or equal to half a dimension of the first antenna element in the second direction.

### Sixth Aspect

The antenna module according to any one of First to Fifth aspects further includes a feeder circuit disposed at the second surface to provide high-frequency signals to the first antenna element and the second antenna element. In the antenna module according to any one of First to Fifth aspects, when viewed in plan in a normal direction of the first substrate, the third substrate is disposed between the feeder circuit and the second substrate.

### Seventh Aspect

In the antenna module according to Sixth Aspect, a dimension of the feeder circuit in the first direction is greater than a dimension of the third substrate in the first direction.

### Eighth Aspect

In the antenna module according to any one of First to Seventh Aspects, when viewed in plan in a normal direction of the second substrate, the second antenna element overlaps the third substrate.

### Ninth Aspect

In the antenna module according to any one of First to Eighth Aspects, a dimension of the second substrate in the first direction is greater than a sum of a dimension of the first substrate and a dimension of the third substrate in the first direction.

### Tenth Aspect

In the antenna module according to any one of First to Ninth Aspects, a size of the first antenna element is greater than a size of the second antenna element.

### Eleventh Aspect

In the antenna module according to any one of First to Tenth Aspects, a dielectric constant of the second substrate is greater than or equal to a dielectric constant of the first substrate.

### Twelfth Aspect

In the antenna module according to Eleventh Aspect, a dielectric constant of the third substrate is greater than or equal to a dielectric constant of the second substrate.

### Thirteenth Aspect

In the antenna module according to any one of First to Twelfth Aspects, a first recessed portion is formed on the second surface of the first substrate, and the third substrate is connected to the first substrate in the first recessed portion.

### Fourteenth Aspect

In the antenna module according to any one of First to Thirteenth Aspects, a second recessed portion is formed on the fourth surface of the second substrate, and the third substrate is connected to the second substrate in the second recessed portion.

### Fifteenth Aspect

In the antenna module according to any one of First to Fourteenth Aspects, the feed line is disposed on an outer surface of the third substrate.

### Sixteenth Aspect

In the antenna module according to any one of First to Fourteenth Aspects, the feed line is disposed at an inner layer of the third substrate.

### Seventeenth Aspect

In the antenna module according to any one of First to Sixteenth Aspects, the third ground electrode is disposed on an outer surface of the third substrate.

### Eighteenth Aspect

In the antenna module according to any one of First to Sixteenth Aspects, the third ground electrode is disposed at an inner layer of the third substrate.

### Nineteenth Aspect

In the antenna module according to any one of First to Eighteenth Aspects, the second antenna element includes a plurality of radiation electrodes, the second substrate includes a plurality of first sub-substrates on which the plurality of radiation electrodes are respectively disposed, and the third substrate is connected to each of the plurality of first sub-substrates.

### Twentieth Aspect

In the antenna module according to any one of First to Eighteenth Aspects, the second antenna element includes a plurality of radiation electrodes, the second substrate includes a plurality of first sub-substrates on which the plurality of radiation electrodes are respectively disposed, and the third substrate includes a plurality of second sub-substrates to transmit high-frequency signals to the plurality of first sub-substrates, respectively.

### Twenty First Aspect

In the antenna module according to any one of First to Eighteenth Aspects, the second antenna element includes a plurality of radiation electrodes, and the third substrate includes a plurality of second sub-substrates to transmit high-frequency signals to the plurality of radiation electrodes, respectively.

### Twenty Second Aspect

A communication device according to an aspect includes the antenna module according to any one of First to Twenty First Aspects.

### Twenty Third Aspect

A substrate connection structure according to an aspect includes a first substrate to a third substrate, a first ground electrode to a third ground electrode, and a feed line. The first substrate and the second substrate each have a flat shape capable of receiving a radiation electrode. The third substrate is connected to the first substrate and the second substrate, and has no flexibility. The first ground electrode is disposed at the first substrate, and the second ground electrode is disposed at the second substrate. The third ground electrode is disposed at the third substrate, and electrically connects the first ground electrode and the second ground electrode to each other. The feed line is disposed at the third substrate, and transmits a high-frequency signal from the first substrate to the second substrate. A normal direction of the first substrate and a normal direction of the second substrate differ from each other.

The embodiments described herein are to be regarded as illustrative and non-limiting in all respects. The scope of the present invention is defined by the claims, rather than the description of the embodiments, and is intended to cover all modifications within the meaning and scope of the claims and their equivalents.

### REFERENCE SIGNS LIST

10 communication device
100, 100A to 100I antenna module
110 RFIC
111A to 111H, 113A to 113H, 117A, 117B switch
112AR to 112HR low-noise amplifier
112AT to 112HT power amplifier
114A to 114H attenuator
115A to 115H phase shifter
116A, 116B signal combiner/splitter
118A, 118B mixer
119A, 119B amplifier circuit
120 antenna device
121A to 121C radiation electrode
125 SiP module
130B1 to 130B4, 130C1 to 130C4 sub-substrate
130A to 130G dielectric substrate
131, 133, 135 top surface
132, 134, 136 rear surface
141 to 148, 143A feed line
143A1 first portion
143A2 second portion
151 to 157 solder bump
160, 161 recessed portion
180 connector
200 BBIC
300 substrate connection structure
GND1, GND2, GND5, GND31, GND32, GND41 ground electrode
OP opening
SP1 to SP3 feed point

1. An antenna module, comprising:
a first substrate that has a flat shape and has a first surface and a second surface opposite to each other;
a second substrate that has a flat shape and has a third surface and a fourth surface opposite to each other;
a third substrate that is connected to the second surface of the first substrate and the fourth surface of the second substrate, and that is rigid;
a first ground electrode that is disposed at the first substrate;
a first antenna element that is disposed at the first substrate at a position closer to the first surface with respect to the first ground electrode;
a second ground electrode that is disposed at the second substrate;
a second antenna element that is disposed at the second substrate at a position closer to the third surface with respect to the second ground electrode;
a third ground electrode that is disposed at the third substrate, and electrically connects the first ground electrode and the second ground electrode to each other; and
a feed line that is disposed at the third substrate, and transmits a high-frequency signal from the first substrate to the second substrate,
wherein when a normal direction of the first substrate is defined as a first direction, and a normal direction of the second substrate is defined as a second direction, the first direction and the second direction differ from each other.

2. The antenna module according to claim 1,
wherein the third ground electrode and the feed line are disposed at the third substrate to face the second surface and the fourth surface, and
wherein the third ground electrode is disposed along both sides of the feed line in an extension direction of the feed line.

3. The antenna module according to claim 1,
wherein the feed line is disposed at the third substrate to face the second surface and the fourth surface, and
wherein the third ground electrode is disposed at a position opposite to the feed line.

4. The antenna module according to claim 1,
wherein when viewed in plan in a normal direction of the first substrate, the first antenna element does not overlap the third substrate.

5. The antenna module according to claim 4,
wherein a shortest distance from an end portion of the first antenna element in the second direction to an end portion of the first substrate in the second direction is less than or equal to half a dimension of the first antenna element in the second direction.

6. The antenna module according to claim 1, further comprising:
a feeder circuit disposed at the second surface to provide high-frequency signals to the first antenna element and the second antenna element,
wherein when viewed in plan in a normal direction of the first substrate, the third substrate is disposed between the feeder circuit and the second substrate.

7. The antenna module according to claim 1,
wherein when viewed in plan in a normal direction of the second substrate, the second antenna element overlaps the third substrate.

8. The antenna module according to claim 1,
wherein a dimension of the second substrate in the first direction is greater than a sum of a dimension of the first substrate and a dimension of the third substrate in the first direction.

9. The antenna module according to claim 1,
wherein a size of the first antenna element is greater than a size of the second antenna element.

10. The antenna module according to claim 1,
wherein a dielectric constant of the second substrate is greater than or equal to a dielectric constant of the first substrate, and
wherein a dielectric constant of the third substrate is greater than or equal to a dielectric constant of the second substrate.

11. The antenna module according to claim 1,
wherein a first recessed portion is formed on the second surface of the first substrate, and the third substrate is connected to the first substrate in the first recessed portion.

12. The antenna module according to claim 1,
wherein the feed line is disposed on an outer surface of the third substrate.

13. The antenna module according to claim 1,
wherein the feed line is disposed at an inner layer of the third substrate.

14. The antenna module according to claim 1,
wherein the third ground electrode is disposed on an outer surface of the third substrate.

15. The antenna module according to claim 1,
wherein the third ground electrode is disposed at an inner layer of the third substrate.

16. The antenna module according to claim 1,
wherein the second antenna element includes a plurality of radiation electrodes,
wherein the second substrate includes a plurality of first sub-substrates on which the plurality of radiation electrodes are respectively disposed, and
wherein the third substrate is connected to each of the plurality of first sub-substrates.

17. The antenna module according to claim 1,
wherein the second antenna element includes a plurality of radiation electrodes,
wherein the second substrate includes a plurality of first sub-substrates on which the plurality of radiation electrodes are respectively disposed, and
wherein the third substrate includes a plurality of second sub-substrates to transmit high-frequency signals to the plurality of first sub-substrates, respectively.

18. The antenna module according to claim 1,
wherein the second antenna element includes a plurality of radiation electrodes, and
wherein the third substrate includes a plurality of second sub-substrates to transmit high-frequency signals to the plurality of radiation electrodes, respectively.

19. A communication device, comprising:
the antenna module according to claim 1.

20. A substrate connection structure, comprising:
a first substrate and a second substrate each having a flat shape capable of receiving a radiation electrode;
a third substrate connected to the first substrate and the second substrate, and is rigid;
a first ground electrode disposed at the first substrate;
a second ground electrode disposed at the second substrate;
a third ground electrode disposed at the third substrate, and electrically connecting the first ground electrode and the second ground electrode to each other; and
a feed line disposed at the third substrate to transmit a high-frequency signal from the first substrate to the second substrate,
wherein a normal direction of the first substrate and a normal direction of the second substrate differ from each other.
